(19) United States
(12) Patent Application Publication
(10) Pub. No.: US 2022/0169371 A1
(43) Pub. Date: Jun. 2, 2022

(54) AIRCRAFT

(71) Applicant: LIFT AIR GMBH, Hörselberg-Hainich (DE)

(72) Inventors: Thomas Strieker, Verl (DE); Torsten Cymanek, Ettlingen (DE)

(21) Appl. No.: 17/442,890

(22) PCT Filed: Mar. 19, 2020
(86) PCT No.: PCT/EP2020/057609

§ 371 Date: Nov. 4, 2021

(30) Foreign Application Priority Data
Mar. 25, 2019 (DE) 10 2019 107 593.9

(51) Int. Cl. B64C 27/22; B64D 27/24; B60L 50/60; B64C 9/00; B64C 27/46

(52) U.S. Cl. CPC B64C 27/22; B64D 27/24; B60L 50/60; B64C 2009/005; B64C 27/46; B60L 2200/10; B64C 9/00

(57) ABSTRACT

The invention relates to an aircraft with a longitudinal central axis, comprising: a fuselage structure (2) which is designed to accommodate persons and/or payload; a wing structure (3) which has at least two wing halves (3.1) which are attached to the fuselage structure (2) and which have a fuselage-side main region (H) and a tip region (S); at least one forward propulsion unit (4) which is designed to generate a forward force, acting in the direction of the central axis, on the aircraft; at least four lifting propulsion units (5) which are designed to generate a lift force, acting in the direction of the central axis, on the aircraft.

The present invention relates to an aircraft according to claim 1, as well as to a method for stabilizing the aircraft according to claim 13, a method for starting the aircraft according to claim 14, as well as to a method for landing the aircraft according to claim 15.

In many applications for aircrafts, in particular in urban regions, surfaces for starting and/or landing the aircraft are not available so that an aircraft is desirable which is able to vertically start and/or land.

Typically, for such applications, so-called quadrocopters are used, which have four rotors that are spaced from one another. Furthermore, variants of the quadrocopters are also known, which have more than four rotors, such as, for example, the so-called octocopter. Such known aircrafts are characterized by good hover flight characteristics. Such aircrafts, however, do not have any rigid wing profiles, whereby the achievable travel velocities and coverage values are limited, since the rotors need to permanently generate an uplift force during the flight. Hereby, an efficient medium and/or long-distance operation cannot be realized.

For this reason, aircrafts can be found in the current state of the art, which have both rigid wing profiles and pivotable and/or tiltable rotors. In the printed publication WO 2017/021 391 A1, such an aircraft with a pivotable propeller is described. Also, in the printed publication DE 10 2015 006 511 A1, pivotable or tiltable propellers are described.

Moreover, aircrafts of the state of the art are known, which have separate propulsion and lifting propulsion units. The lifting rotors are arranged, for example, in recesses within the wings, as described in the printed publication EP 3 206 949 B1. These recesses, however, result in additional turbulences of the air flows which, for an efficient uplift creation, should actually run along the wing profiles in a laminar manner. Conventionally, cover flaps are therefore used which are opened during a hover flight and closed during a travel flight so as to close the above-mentioned recesses in the wings.

In the known state of the art, additional supporting structures are moreover disclosed, which are attached to a fuselage and/or a wing profile. The lifting rotors are attached to the supporting structures. In flight operation, the supporting structures may result in disadvantageous turbulences, whereby the air resistance of the aircrafts described above is increased and the efficiency during the travel flight is reduced. Furthermore, the additional weight of the supporting structures may result in an unfavorable weight distribution of the aircraft, whereby the flight stability and/or the flight characteristics of the aircraft are deteriorated. The supporting structures moreover represent an additional error susceptibility or failure probability, since the connection points between the supporting structure and the fuselage and/or the wing profile are sometimes exposed to high loads by lever and vibration forces.

The above solutions of the state of the art are comparatively expensive, since expensive pivot, tilt and/or flap mechanisms as well as additional supporting structures are used, whereby the error susceptibility or failure probability of the aircraft is increased.

It is therefore obvious from the previous state of the art that a satisfactory technical solution for the disadvantages described above is still nonexistent.

It is therefore the task of the present invention to provide a comparatively simple and secure aircraft, which, on the one hand, allows vertically starting and/or landing, and, on the other hand, makes an efficient medium and/or long-distance operation possible, whereby maximum possible security is intended to be achieved by a reduced error susceptibility and/or reduced failure probability in operating the aircraft.

The task is solved by an aircraft according to claim 1, as well as a method for stabilizing the aircraft according to claim 13, a method for starting the aircraft according to claim 14, as well as a method for landing the aircraft according to claim 15.

The task of the invention is in particular solved by an aircraft having a longitudinal central axis, comprising:
a fuselage structure which is designed to accommodate persons and/or payload;
a wing structure which has at least two wing halves which are attached to the fuselage structure and which have a fuselage-side main region and a tip region;
at least one forward propulsion unit which is designed to generate a forward force upon the aircraft acting in the direction of the central axis;
at least four lifting propulsion units which are designed to generate an uplift force upon the aircraft acting in the vertical direction of the central axis;
   wherein the lifting propulsion units are mounted in a directionally fixed manner below the wing halves in the main region and spaced from the surface of the wing halves.

In particular six, preferably eight or more lifting propulsion units are attached in a directionally fixed manner below the wing halves in the main region and spaced from the surface of the wing halves. Preferably, the lifting propulsion units are arranged in the main region of the wings in a distributed manner. By distributed arrangement is understood in this context that the lifting propulsion units are arranged on an axis in a non-linear manner, which allows an advantageous weight distribution to be achieved, and a facilitated balancing into a stable hovering flight position is achieved.

A core idea of the invention is based on the finding that lifting propulsion units attached below the wing halves can generate sufficient uplift force if the lifting propulsion units are correspondingly spaced from the surface of the wing halves. A negative effect of the wing halves upon the air volume flow flowing through one of the lifting propulsion units to the wing surface is reduced. In this case, the air volume flow flowing through the lifting propulsion units runs between the wing halves and the lifting propulsion units in parallel to the wing halves.

Furthermore, it is possible for the uplift forces generated by the individual lifting propulsion units to be superimposed so that the lifting propulsion units generate a sufficiently high entire lifting propulsion force so as to keep the aircraft in a hovering flight and/or to vertically start or land the aircraft.

A further advantage of the invention is that by dispensing with additional supporting structures for the lifting propulsion units and by directly attaching the lifting propulsion units to the wing halves, a construction as simple and secure as possible is achieved.

By attaching the lifting rotors in a fuselage-side main region of the wing halves, low additional mechanical loads at the connection points between the wing halves and the fuselage structure are generated, which would occur, for example, through lever forces or vibrations if the lifting rotors were attached in the tip region of the wing halves.

The forward force generated by the forward propulsion unit can be directed along the central axis in a flight direction of the aircraft depending on the mode of operation of the forward propulsion unit, whereby an acceleration of the aircraft is achieved. Furthermore, the forward force generated by the forward propulsion unit can be directed against the flight direction of the aircraft, whereby a deceleration into the opposite flight direction of the aircraft is achieved.

The forward propulsion unit and the lifting propulsion units are separate propulsion units which can be configured as different propulsion unit types. The use of a separate forward propulsion unit and a plurality of lifting propulsion units therefore allows expensive tilting mechanisms for the lifting propulsion units to be dispensed with.

A further advantage of the invention is that the additional lifting propulsion units result in a redundancy of the propulsion units, whereby the security during flight operation is increased. In cases where individual or a plurality of propulsion and/or lifting propulsion units fail, it is further possible to compensate at any time and without delay the propulsion failures by the further lifting propulsion units, wherein the aircraft can be landed also in case of individual or a plurality of propulsion failures in a secure and controlled manner.

A wing structure is understood to be a plurality of wing profiles preferably attached symmetrically to the fuselage structure, wherein each wing half has different regions. The tip region of one wing half extends from the wing tip in the direction of the fuselage-wing transition over one third, in particular one fourth, preferably one fifth of the entire length of the wing half.

A fuselage-side main region of the wing half is correspondingly understood to be a region between the fuselage-wing transition and the tip region. In other words, the main region of the wing half extends from the fuselage-wing transition in the direction of the wing tip over two thirds, in particular three fourths, preferably four fifths of the entire length of the wing half.

A directionally fixed attachment of the lifting propulsion units is understood in particular so that the lifting propulsion units are not tiltable and/or pivotable.

In a preferred embodiment, the forward propulsion unit and the lifting propulsion unit can be controlled and/or operated independently from one another, whereby a number of different, sometimes complex flight maneuvres is enabled. Especially in starting, landing and stabilizing maneuvres, independently controlling of the forward propulsion units and the lifting propulsion units is advantageous.

Preferably, the lifting propulsion units each have a rotor with at least two rotor blades, wherein the rotor blades of the rotor rotate in operation over a circular rotor surface. Hereby, a sufficiently high uplift force can be generated by the lifting propulsion units. Especially, the rotors of the lifting propulsion units can have exactly two rotor blades which are spaced from one another by 180°. This allows a preferential position for the rotor blades to be set which is advantageous for the air resistance, when the lifting propulsion units are not operated.

A circular rotor surface is in particular understood to be the circular surface, over which a rotor blade slides in operation, thus, when the rotor blade rotates. The radius of the circular rotor surface consequently corresponds to the length of the rotor blade.

In a further embodiment, several of the circular rotor surfaces are oriented in parallel to the central axis and/or in parallel to a transverse axis of the aircraft, whereby the resulting propulsion forces of the lifting propulsion units are generated vertically to the central axis and/or to the transverse axis of the aircraft. The transverse axis can be understood to be an axis which is arranged orthogonally to the central axis. Furthermore, the transverse axis is arranged orthogonally to a vertical axis. The central axis, the transverse axis, and the vertical axis together form an object-related coordinate system, the so-called object coordinate system.

In a particularly preferred embodiment, several of the circular rotor surfaces have an angle of pitch of up to 15°, in particular of up to 10°, preferably of up to 5° to the central axis and/or to a transverse axis. Hereby, a particularly advantageous, stable superimposition of the generated propulsion forces of the lifting propulsion units can be achieved so that the aircraft is capable of remaining in a more stable hover flight.

The circular rotor surfaces are at least in part, in particular half or more covered by the wing halves and/or by the fuselage structure, whereby a particularly compact design is enabled. Furthermore, increased security, in particular for passengers and/or a transported payload is hereby guaranteed, since in a case where one or more of the rotor blades come/s off in operation, the risk that the rotor blade or the rotor blades penetrate/s through the fuselage structure is minimized.

It is furthermore preferred for supporting elements to be arranged on a lower surface area of the wing halves to which the lifting propulsion units can be attached at a distance and spaced from the lower surface of the wing halves. The supporting elements in particular have advantageous dynamic characteristics along the central axis in the flight direction of the aircraft. Due to the supporting elements, it is enabled for the lifting propulsion units to be mounted to the wing halves in a particularly advantageous manner at a predetermined distance. Furthermore, signal and/or power cables can be guided within the supporting elements.

In a preferred embodiment, the distance corresponds at least to a factor of 0.1 or larger, in particular a factor of 0.20 or larger, preferably exactly a factor of 0.25 of the length of the rotor blades, whereby a negative effect of the wing half upon the air volume flow flowing through the circular rotor surface is reduced so that an achievable uplift capacity of the lifting propulsion units is increased.

The lifting propulsion units in particular have an arresting device by means of which the rotor blades of the rotors can be arrested in a preferential position when the lifting propulsion units are not operated. A preferential position in a two-blade rotor is in particular that both rotor blades are oriented in parallel to the central axis of the aircraft. Hereby, the air resistance of the lifting propulsion units is reduced when these are not operated.

In a further embodiment, the lifting propulsion units are controlled so that the lifting propulsion units maintain their preferential position when the lifting propulsion units are not operated. Even without additional mechanical devices, the lifting propulsion units can hereby be held in the preferential position.

Preferably, the rotor blades extend in the preferential position in parallel to the central axis when the rotor has two rotor blades, whereby an air resistance of the lifting propulsion units as low as possible is achieved when the lifting propulsion units are not operated.

It is furthermore preferred for the lifting propulsion units to be driven by electric motors, whereby an instantaneous control and an efficient, low-maintenance operation are enabled. The electric motors are in particular fed by a rechargeable battery or another electrical energy source, such as, for example, a fuel cell. Furthermore, the lifting propulsion units can also be driven mechanically or powered by compressed air.

In a particularly preferred embodiment, the lifting propulsion units are supplied by rechargeable batteries in a decentral manner, wherein the respective rechargeable battery is accommodated in a lifting propulsion unit housing of the respective lifting propulsion unit and/or in the respective supporting element, whereby the individual lifting propulsion units can be operated to be mutually self-sufficient. A failure risk of the entirety of lifting propulsion units is hereby reduced, since even in supply failures of single rechargeable batteries, the remaining lifting propulsion units can further be operated. Furthermore, the rechargeable batteries are thereby arranged spaced from the fuselage structure so that if one or more of the rechargeable batteries catch es or catch fire, a risk of injury and/or a risk of damage to the transported persons and/or to the transported payload is reduced.

In a further preferred embodiment, several, in particular two, preferably three lifting propulsion units are arranged symmetrically to one another in a front edge region below each wing half, and at least one lifting propulsion unit is further arranged symmetrically to one another in a rear edge region below each wing half. The above-described arrangement of the lifting propulsion units offers a particularly advantageous distribution of the lifting propulsion forces of the individual lifting propulsion units so that a particularly stable hover flight is enabled.

In particular, a transition between the fuselage structure and the wing structure is formed to be continuous. Preferably, the aircraft is a flying wing device, in which the wing structure easily merges into the fuselage structure, whereby the aircraft constructively has particularly advantageous lifting propulsion characteristics. This has an advantageous influence upon the efficiency of the aircraft during travel flight.

The task of the invention is moreover solved by a method for stabilizing the aircraft described above, wherein the lifting propulsion units preferably are controlled automatically when the aircraft is in an uncontrolled flight situation so that a controlled flight situation is achieved.

A core idea of the method according to the invention is to achieve additional security for the flight operation of the aircraft. Thus, the method according to the invention enables an automatic intervention to be performed when the aircraft is in an uncontrolled flight situation. By controlling individual lifting propulsion units in a targeted manner, the aircraft can thus be transferred, when it is in an uncontrolled tumbling flight and/or nosedive flight, into a controlled hover flight and be stabilized.

The aircraft may in particular have several sensors for determining the attitude and/or position of the aircraft, such as, for example, one or more inertial sensor systems, a magnetic field sensor, an altitude sensor, and/or a receiver of a global navigation satellite system (GNSS), from the sensor data or reception data of which the attitude and/or position of the aircraft is determined.

Preferably, with the help of a suitable algorithm on the basis of attitude and/or position data progresses which are compared to control commands of the aircraft, the aircraft is able to estimate whether the aircraft is in a controlled flight situation or an uncontrolled flight situation. As soon as it is determined that it is an uncontrolled flight situation, an appropriate control routine may be calculated, for example, and/or a predetermined control routine of the lifting propulsion units may be initiated automatically, which transfers the aircraft into a stable flight attitude.

Furthermore, the additional lifting propulsion units create a certain redundancy in cases where the lifting propulsion unit/s fail/s, for instance. When a lifting propulsion unit fails, a predetermined control routine of the lifting propulsion units can thus be initiated automatically.

Furthermore, the task of the invention is solved by a method for starting the aircraft described above, comprising the following steps:
a starting step in which the lifting propulsion units are controlled so that the aircraft rises vertically until a predetermined height of flight is exceeded, and
a transition step in which the forward propulsion unit is operated so that a forward force acting upon the aircraft in the direction of the central axis is generated, and the aircraft is accelerated,
   wherein the lifting propulsion units are stopped and brought into a preferential position as soon as a predetermined flight velocity is exceeded.

During the starting step, a wind direction is in particular detected and the lifting propulsion units are controlled such that the aircraft is automatically oriented on the basis of the detected wind direction, wherein the forward propulsion unit is controlled so that the aircraft maintains a current position along the central axis. This allows an advantageous orientation of the aircraft to be achieved automatically. Furthermore, drifting off of the aircraft during the landing step by possible external influences such as, for example, inflowing wind, is thereby avoided.

During the transition step and/or after the transition step, the aircraft is preferably controlled by a vertical rudder, elevator, aileron and/or a combination of elevator and aileron, whereby the aircraft can be controlled efficiently during travel flight.

Furthermore, the task of the invention is solved by a method for landing the aircraft described above, comprising the following steps:
a transition step in which the forward propulsion unit is operated so that a forward force acting upon the aircraft in the direction of the central axis against a previous flight direction is generated, and the aircraft is decelerated, wherein the lifting propulsion units are controlled as soon as a predetermined flight velocity is fallen below,
in a landing step, the lifting propulsion units are controlled so that the aircraft descends vertically until the aircraft has landed.

During the landing step, a wind direction is in particular detected and the lifting propulsion units are controlled such that the aircraft is automatically oriented on the basis of the detected wind direction, wherein the forward propulsion unit is controlled so that the aircraft maintains a current position along the central axis. This allows an advantageous orientation of the aircraft to be achieved automatically. Furthermore, drifting off of the aircraft during the landing step by possible external influences such as, for example, inflowing wind, is thereby avoided.

During the transition step and/or before the transition step, the aircraft is preferably controlled by a vertical rudder, elevator, aileron and/or a combination of elevator and aileron, whereby the aircraft can be controlled efficiently during travel flight.

Further embodiments result from the subclaims.

The invention will be described hereinafter on the basis of nonrestrictive exemplary embodiments and will be further explained with reference to the attached drawings. Shown are in:

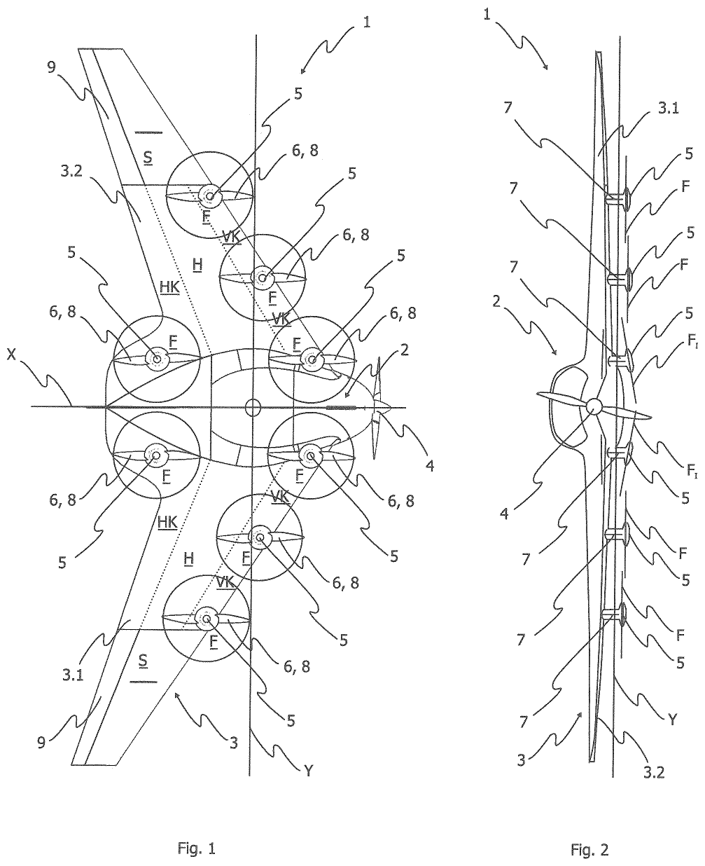

FIG. 1 a schematic view of a bottom side of an aircraft according to an exemplary embodiment of the present invention;

FIG. 2 a schematic front view of the aircraft according to an exemplary embodiment of the present invention;

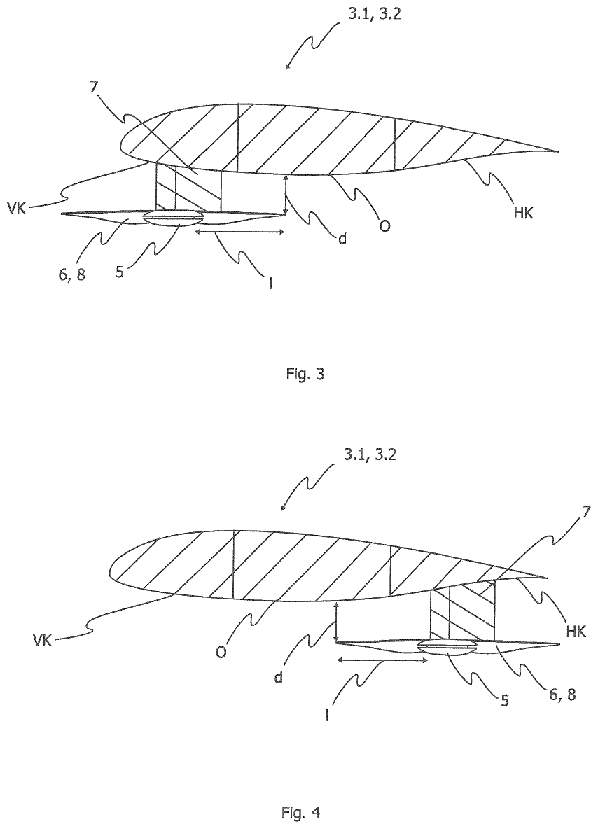

FIG. 3 a detailed view of a lifting propulsion unit of the aircraft attached in a front edge region of the wing half according to an exemplary embodiment of the present invention; and

FIG. 4 a detailed view of a lifting propulsion unit of the aircraft attached in a rear edge region of the wing half according to an exemplary embodiment of the present invention.

In FIG. 1, a schematic view of the bottom side of an aircraft 1 according to an exemplary embodiment of the present invention is shown. The aircraft 1 has a fuselage structure 2. Furthermore, a longitudinal central axis X forming an axis of symmetry of the aircraft is illustrated in FIG. 1.

FIG. 1 moreover shows a wing structure 3 having two wing halves 3.1 and 3.2 attached to the fuselage structure. The wing halves 3.1 and 3.2 extend symmetrically to the central axis X at an angle of about 65° between the central axis X and the wing halves. It is in particular conceivable for the angle to adopt another value in the range of 25° to 90°. Orthogonally to the central axis, a transverse axis Y is plotted. The transverse axis Y runs through the center of gravity of the aircraft 1.

Each of the wing halves 3.1 and 3.2 illustrated in FIG. 1 has two different regions, namely a tip region S and a fuselage-side main region H. In the illustrated exemplary embodiment, the tip region S of the wing half 3.1 or 3.2 extends from the wing tip in the direction of the fuselage-wing transition over a fourth of the entire length of the wing half 3.1 or 3.2. At the rear wing edge of the two wing halves 3.1 and 3.2, so-called elevons 9 forming a combination of elevator and aileron are attached in the tip region S.

The fuselage-side main region H of the wing half 3.1 or 3.2 illustrated in FIG. 1 extends from the fuselage-wing transition in the direction of the wing tip over three fourths of the entire length of the wing half.

The aircraft 1 illustrated in FIG. 1 moreover has a forward propulsion unit 4, which is configured here as a propeller drive 4. Propulsion types other than the forward propulsion unit 4 are conceivable. The forward propulsion unit 4 is attached to the nose of the fuselage structure 2 so that the forward propulsion unit 4 is able to generate a forward force along the central axis X. Other positions at the fuselage structure 2 or the wing structure 3, at which the forward propulsion unit 4 or several forward propulsion units are attached, are not illustrated but possible.

The aircraft 1 of FIG. 1 in total has eight lifting propulsion units 5, which are arranged symmetrically to one another with respect to the central axis X at the bottom side of the wing halves 3.1 and 3.2 in a main region H. Thus, four lifting propulsion units 5 are assigned to each wing half 3.1 or 3.2. In a front edge region VK extending along a front edge of the respective wing half 3.1 or 3.2, in each case three of the four assigned lifting propulsion units 5 are situated spaced from one another. In a rear edge region HK of the wing halves extending along a rear edge of the respective wing half 3.1 or 3.2, in each case one lifting propulsion unit 5 is situated in the illustrated exemplary embodiment.

The lifting propulsion units 5 are designed as rotors 6, which have two rotor blades 8 spaced by 180°. In the illustrated exemplary embodiment, the lifting rotors 6 are in the preferential position. The rotor blades 8 of the lifting rotors 6 are oriented in parallel to the central axis X. Furthermore, the circular rotor surfaces F are illustrated in FIG. 1.

FIG. 2 shows a schematic front view of the exemplary embodiment illustrated in FIG. 1 of the aircraft 1 according to the invention. In FIG. 2, the fuselage structure 2 is shown which merges continuously into the wing structure 3. The wing structure has two wing halves 3.1 and 3.2. Moreover, the forward propulsion unit 4 at the nose of the fuselage structure 2 is shown.

At the wing halves 3.1 and 3.2, in each case three of the lifting propulsion units 5 attached to the front edge region VK are shown from the front. The lifting propulsion units 5 are attached to the wing halves 3.1 and 3.2 directionally fixed by the supporting elements 7 so that the lifting propulsion units 5 are held at the wing halves 3.1 and 3.2 and spaced from the lower surface O. Furthermore, the circular rotor surfaces F of the lifting propulsion units are schematically illustrated in FIG. 2. The circular rotor surfaces F of the outer four lifting propulsion units 5 run in parallel to the central axis (not illustrated), as well as in parallel to the transverse axis Y. The circular rotor surfaces F_{I} of the four lifting propulsion units 5 (only two of the lifting propulsion units 5 are illustrated for perspective reasons), which are arranged closer to the fuselage-wing transition, have an angle of pitch of 10° to the transverse axis Y. These four pitched lifting propulsion units 5 each are pitched in the direction of the fuselage structure 2.

FIG. 3 shows a detailed view of a lifting propulsion unit 5 attached to one wing half 3.1 or 3.2. A cross-section of the wing half 3.1 or 3.2 is shown, to which a supporting element 7 is attached at the wing in the front edge region VK. In FIG. 3, no lifting propulsion unit 5 is shown in the rear edge region HK. The lifting propulsion unit 5 is fixed to the supporting element 7, wherein the lifting propulsion unit 5 depicts a rotor 6 having two rotor blades 8. The rotor 6 is shown in a preferential position.

Furthermore, the length of the rotor blades 8 is shown in FIG. 3. The lifting propulsion unit 5 is spaced from the lower surface O of the wing half 3.1 or 3.2 by the distance d. The distance d is the shortest distance between the lower surface O and the lifting propulsion unit 5, wherein the lifting propulsion unit 5 has a rotor 6 having two rotor blades 8, as described above.

FIG. 4 likewise shows a detailed view of a lifting propulsion unit 5 attached to one wing half 3.1 or 3.2. In FIG. 4, a cross-section of the wing half 3.1 or 3.2 is shown, to which a supporting element 7 is fixed to the wing in the rear edge region HK. No lifting propulsion unit 5 is shown in FIG. 4 in the front edge region VK. The lifting propulsion unit 5 is fixed to the supporting element 7, wherein the lifting propulsion unit 5 depicts a rotor 6 having two rotor blades 8. In FIG. 4 as well, the rotor 6 is shown in a preferential position.

Furthermore, FIG. 4 shows the length of the rotor blades 8. The lifting propulsion unit 5 is spaced from the lower surface O of the wing half 3.1 or 3.2 by the distance d, wherein the distance d is the shortest distance between the lower surface O and the lifting propulsion unit 5.

### LIST OF REFERENCE NUMERALS

1 aircraft
2 fuselage structure
3 wing structure
3.1 first wing half
3.2 second wing half
4 forward propulsion unit
5 lifting propulsion unit
6 rotor
7 supporting element/attachment structure
8 rotor blade
9 elevator, aileron and/or a combination thereof (elevon)
d distance
F circular rotor surface
F_{I} pitched circular rotor surface
H fuselage-side main region of the wing halves
HK rear edge region of the wing halves
I rotor blade length
O lower surface portion of the wing halves
S tip region of the wing halves
VK front edge region of the wing halves
X longitudinal central axis of the aircraft
Y transverse axis of the aircraft

1. An aircraft (1) having a longitudinal central axis (X), comprising:
a fuselage structure (2) which is designed to accommodate persons and/or payload;
a wing structure (3) which has at least two wing halves (3.1, 3.2) which are attached to the fuselage structure (2) and which have a fuselage-side main region (H) and a tip region (S);
at least one forward propulsion unit (4) which is designed to generate a forward force upon the aircraft (1) acting in the direction of the central axis (X);
at least four lifting propulsion units (5) which are designed to generate an uplift force upon the aircraft (1) acting in the vertical direction of the central axis (X);
wherein the lifting propulsion units (5) are attached in a directionally fixed manner below the wing halves (3.1, 3.2) in the main region (H) and spaced from the surface of the wing halves (3.1, 3.2).

2. The aircraft (1) according to claim 1,
characterized in that
the forward propulsion unit (4) and the lifting propulsion units (5) are able to be controlled and/or operated independently from one another.

3. The aircraft (1) according to claim 1,
characterized in that
the lifting propulsion units (5) each have a rotor (6) with at least two rotor blades (8), wherein the rotor blades (8) of the rotor (6) rotate in operation over a circular rotor surface (F).

4. The aircraft (1) according to claim 1,
characterized in that
several of the circular rotor surfaces (F) are oriented in parallel to the central axis (X) and/or in parallel to a transverse axis (Y) of the aircraft (1).

5. The aircraft (1) according to claim 1,
characterized in that
several of the circular rotor surfaces (F) have an angle of pitch of up to 15°, in particular of up to 10°, preferably of up to 5° to the central axis (X) and/or to the transverse axis (Y).

6. The aircraft (1) according to claim 1,
characterized in that
the circular rotor surfaces (F) are at least in part, in particular half or more covered by the wing halves and/or by the fuselage structure (2).

7. The aircraft (1) according to claim 1,
characterized in that
supporting elements (7) are arranged on a lower surface area (O) of the wing halves (3.1, 3.2) to which the lifting propulsion units (5) are attachable at a distance (d) and spaced from the lower surface of the wing halves (3.1, 3.2).

8. The aircraft (1) according to claim 1,
characterized in that
the distance (d) corresponds at least to a factor of 0.1 or larger, in particular a factor of 0.20 or larger, preferably exactly a factor of 0.25 of the length (1) of the rotor blades (8).

9. The aircraft (1) according to claim 1,
characterized in that
the lifting propulsion units (5) have an arresting device by means of which the rotor blades (8) of the rotors (6) are arrestable in a preferential position when the lifting propulsion units (5) are not operated.

10. The aircraft (1) according to claim 1,
characterized in that
the lifting propulsion units (5) are controlled so that the lifting propulsion units (5) maintain their preferential position when the lifting propulsion units (5) are not operated.

11. The aircraft (1) according to claim 1,
characterized in that
the rotor blades (8) extend in the preferential position in parallel to the central axis (X) when the rotor (6) has two rotor blades (8).

12. The aircraft (1) according to claim 1,
characterized in that
the lifting propulsion units (5) are driven by electric motors.

13. The aircraft (1) according to claim 1,
characterized in that
the lifting propulsion units (5) are supplied by rechargeable batteries in a decentral manner, wherein the respective rechargeable battery is accommodated in a lifting propulsion unit housing of the respective lifting propulsion unit (5) and/or in the respective supporting element (7).

14. The aircraft (1) according to claim 1,
characterized in that
several, in particular two, preferably three lifting propulsion units (5) are arranged symmetrically to one another in a front edge region (VK) below each wing half (3.1, 3.2), and at least one lifting propulsion unit (5) is arranged symmetrically to one another in a rear edge region (HK) below each wing half (3.1, 3.2).

15. The aircraft (1) according to claim 1,
characterized in that
a transition between the fuselage structure (2) and the wing structure (3) is formed to be continuous.

16. A method for stabilizing the aircraft (1) according to claim 1,
characterized in that
the lifting propulsion units (5) preferably are controlled automatically when the aircraft (1) is in an uncontrolled flight situation so that a controlled flight situation is achieved.

17. A method for starting the aircraft (1) according to claim 1, comprising the following steps:
a starting step in which the lifting propulsion units (5) are controlled so that the aircraft (1) rises vertically until a predetermined height of flight is exceeded, and
a transition step in which the forward propulsion unit (4) is operated so that a forward force acting upon the aircraft (1) in the direction of the central axis (X) is generated, and the aircraft (1) is accelerated,
wherein the lifting propulsion units (5) are stopped and brought into a preferential position as soon as a predetermined flight velocity is exceeded.

18. The method for starting the aircraft (1) according to claim 17,
characterized in that
during the starting step, a wind direction is detected, and the lifting propulsion units (5) are controlled such that the aircraft (1) is automatically oriented on the basis of the detected wind direction, wherein the forward propulsion unit (4) is controlled so that the aircraft (1) maintains a current position along the central axis (X).

19. The method for starting the aircraft (1) according to claim 17,
characterized in that
during the transition step and/or after the transition step, the aircraft (1) is controlled by a vertical rudder, elevator, aileron and/or a combination of elevator and aileron (9).

20. A method for landing the aircraft (1) according to claim 1, comprising the following steps:
a transition step in which the forward propulsion unit (4) is operated so that a forward force acting upon the aircraft (1) in the direction of the central axis (X) against a previous flight direction is generated, and the aircraft (1) is decelerated,
wherein the lifting propulsion units (5) are controlled as soon as a predetermined flight velocity is fallen below,
in a landing step, the lifting propulsion units (5) are controlled so that the aircraft (1) descends vertically until the aircraft (1) has landed.

21. The method for landing the aircraft (1) according to claim 20,
characterized in that
during the landing step, a wind direction is detected, and the lifting propulsion units (5) are controlled such that the aircraft is automatically oriented on the basis of the detected wind direction, wherein the forward propulsion unit (4) is controlled so that the aircraft (1) maintains a current position along the central axis (X).

22. The method for landing the aircraft (1) according to claim 20,
characterized in that
during the transition step and/or after the transition step, the aircraft (1) is controlled by a vertical rudder, elevator, aileron and/or a combination of elevator and aileron (9).
